(19) United States
(12) Patent Application Publication
(10) Pub. No.: US 2022/0228807 A1
(43) Pub. Date: Jul. 21, 2022

(54) MODULE AND APPARATUS FOR DRYING CONTAINERS

(71) Applicant: EUROPOOL - S.R.L., 43036 FIDENZA (PARMA) (IT)

(72) Inventor: Marco PRIERO, Fidenza (IT)

(21) Appl. No.: 17/646,425

(22) Filed: Dec. 29, 2021

(30) Foreign Application Priority Data
Jan. 15, 2021 (EP) 21151926.9

(51) Int. Cl. F26B 21/00; F26B 15/18

(52) U.S. Cl. CPC F26B 21/004; F26B 15/18

(57) ABSTRACT

Drying module (1) for drying containers (100), comprising:
a tunnel (2) inside which the containers (100) move forwards along an advancement trajectory (T);
conveying means (3) for conveying the containers (100) inside the tunnel (2);
a first row of tubular elements (4) arranged inside the tunnel (2), each tubular element (4) of the first row having an extension along a corresponding prevalent direction (A-A) and having an opening (4a) to dispense air onto the containers (100) in transit in the tunnel (2), one of more of the tubular elements (4) of the first row being telescopic so as to have an adjustable length according to the corresponding prevalent direction (A-A).

### The object of the present invention is a module and an apparatus for drying containers, in particular the outer surface thereof.

The invention applies to the field of bottling, packaging for the food, pharmaceutical or similar sectors.

Drying apparatuses exist on the market that subject containers in transit in a drying tunnel to the action of an air knife tilted in a transverse direction. It is a structurally simple solution that does not however permit individual adjustment of the air jets.

Amongst known drying apparatuses, we mention the one disclosed in European patent EP 2072405 in the name of the Applicant.

This apparatus comprises a drying tunnel provided with hoses ending with nozzles for blowing air onto the containers in transit in the tunnel. The nozzles are bolted singly to a transverse rod whose ends are adjustable in height. Further, the rod is rotatable around its own axis. In this manner, it is possible to vary the position of each nozzle on three axes. Further, it is possible to vary simultaneously the inclination of the entire row of nozzles by acting on the ends of the rod and by rotating the rod.

One of the limits of the solution that has been just described lies in the expenditure of time linked to the adjustment of the individual nozzle, which is supported by a support element fixed adjustably to the transverse rod.

Further, the adjusting system for adjusting the single nozzle is not easily accessible.

Further, the hoses are subject to load losses that cause a reduction in flowrate and air flow pressure exiting the nozzles.

Further, it would be desirable to improve the adjusting precision of the position of the nozzles.

In this context, the technical task at the basis of the present invention is to propose a module and a drying apparatus of containers which overcomes the aforementioned drawbacks of the prior art cited above.

In particular, the object of the present invention is to make available a module and an apparatus for drying containers that enable drying efficiency to be improved with respect to known solutions, reducing head losses in conveying air and collecting points of water and/or liquids.

Another object of the present invention is to make available a module and an apparatus for drying containers in which it is possible to adjust the position of the individual nozzle of the tunnel rapidly and precisely.

Another object of the present invention is to propose a module and an apparatus for drying containers that are quickly adaptable to the size change, at the same time avoiding structural complexity.

The stated technical task and specified objects are substantially achieved by an apparatus for drying containers comprising:
a tunnel inside which the containers move forwards along an advancement trajectory;
conveying means for conveying the containers inside the tunnel;
at least one first row of tubular elements arranged inside the tunnel, each tubular element of the first row having an extension along a corresponding prevalent direction and having an opening to dispense air onto the containers in transit in the tunnel, one of more of the tubular elements of the first row being telescopic so as to have an adjustable length according to the corresponding prevalent direction.

In accordance with one aspect of the invention, the drying module further comprises a second row of tubular elements arranged inside the tunnel.

In particular, the first row and the second row are arranged on sides opposite the advancement trajectory of the containers inside the tunnel. Each tubular element of the second row extends along a corresponding prevalent direction and has an opening to dispense air onto the containers in transit in the tunnel.

In accordance with one aspect of the invention, one of more of the tubular elements of the second row is telescopic so as to have an adjustable length according to the corresponding prevalent direction.

According to one preferred embodiment, all the tubular elements are telescopic.

According to one preferred embodiment, the tubular elements are made of a stiff material.

In accordance with one aspect of the invention, the drying module further comprises an air supply system comprising:
at least one blower;
a first conduit from which the tubular elements of the first row branch off;
a second conduit from which the tubular elements of the second row branch off.

In particular, the first conduit and the second conduit are parallel to one another and are in fluid communication with the blower.

In accordance with one embodiment, each tubular element of the first row branches off from the first conduit, the prevalent direction thereof being arranged on a plane substantially orthogonal to the first conduit and each tubular element of the second row branches off from the second conduit, the prevalent direction thereof being arranged on a plane substantially orthogonal to the second conduit.

In accordance with one aspect of the invention, the drying module further comprises a control system configured to vary the distance between the first conduit and the second conduit and/or to adjust the height of said conduits with respect to the conveying means.

In accordance with one aspect of the invention, the tubular elements are rotatably fitted to the corresponding conduits in such a manner that it is possible to vary the inclination thereof singly.

Preferably, each tubular element is rotatably fitted to the corresponding conduit so as to rotate with respect to an axis that is orthogonal to the longitudinal extension of the conduit.

In accordance with one aspect of the invention, the tubular elements are rotatable around the corresponding prevalent direction.

In accordance with one aspect of the invention, the opening of each tubular element is made as a slit in a free end portion of the tubular element.

According to one embodiment, the free end portion has an open end to which a closure is applied so as to convey the air to the corresponding opening.

Preferably, the open end is cut at 45° with respect to the corresponding prevalent direction.

The stated technical task and the specified objects are substantially achieved by a drying apparatus di containers comprising a plurality of drying modules according to the present invention, which are arranged in a cascade.

According to one embodiment, the conveying means of the containers is made as a single device that traverses all tunnels of the drying modules.

Further characteristics and advantages of the present invention will more fully emerge from the non-limiting description of a preferred but not exclusive embodiment of a module and of an apparatus for drying containers, as illustrated in the accompanying drawings, in which:

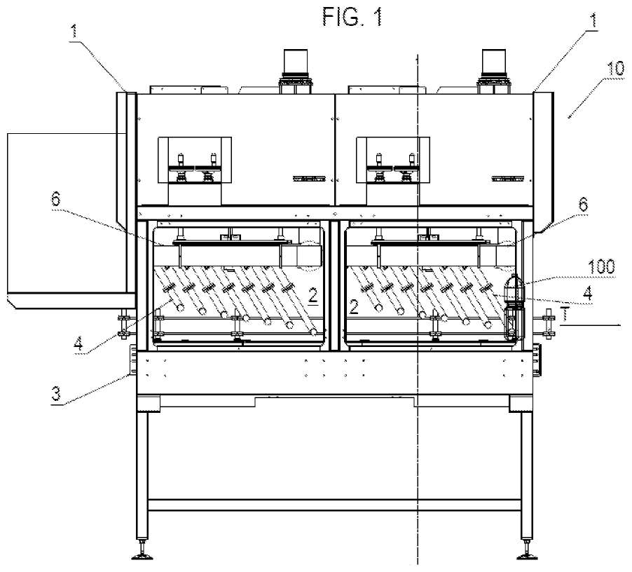

FIG. 1 illustrates a drying module for drying containers, according to the present invention, in a side view;

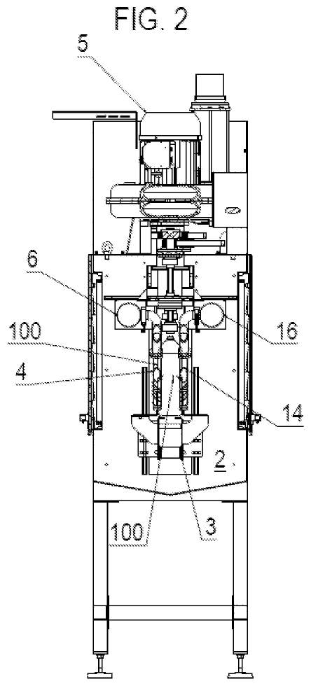

FIG. 2 illustrates the drying module of FIG. 1 in a frontal view;

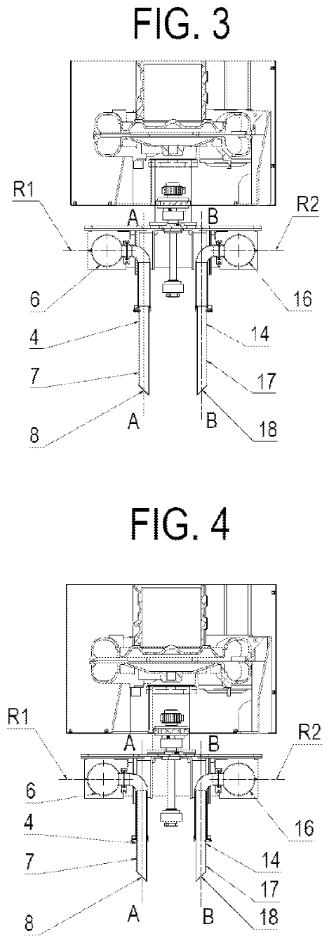

FIGS. 3 and 4 illustrate in detail a part of the drying module of FIG. 2, with telescopic tubular elements respectively in retracted position and in extended position;

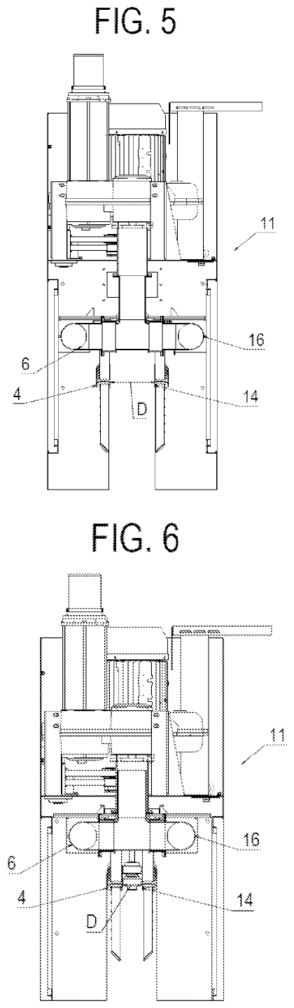

FIGS. 5 and 6 illustrate in detail a part of the drying module of FIG. 2, in two different adjusting configurations of the distance and of the height of the conduits;

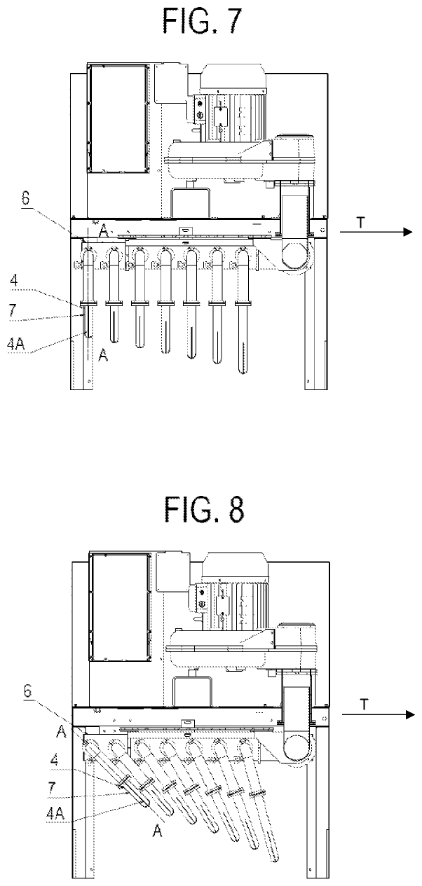

FIGS. 7 and 8 illustrate a part of the drying module of FIG. 1, wherein the tubular elements of the first row have different inclinations from the advancement trajectory;

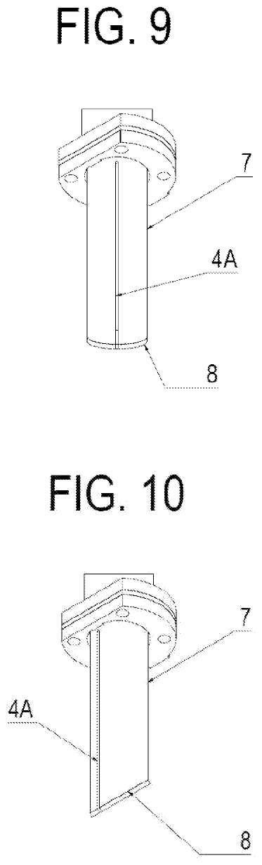

FIGS. 9 and 10 illustrate a free end portion of the tubular element, in two different positions;

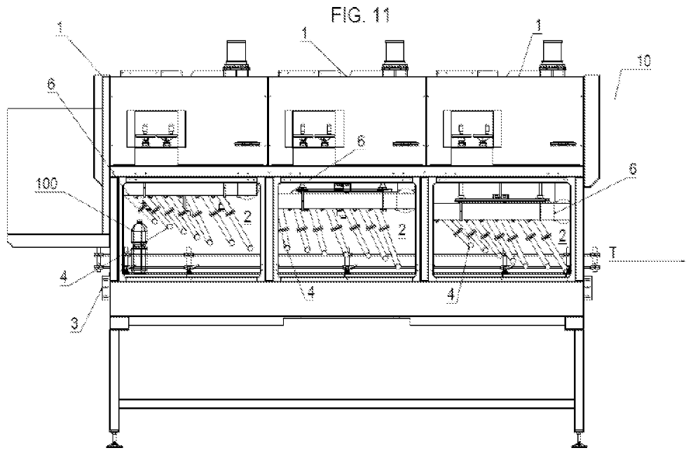

FIG. 11 illustrates a drying apparatus for drying containers, according to the present invention, in a side view.

With reference to the figures, number 1 indicates a drying module of containers 100 like bottles, jerry cans, dispensers or the like.

The drying module 1 comprises a tunnel 2 inside which the containers 100 advance along an advancement trajectory T.

In accordance with the embodiment disclosed and illustrated herein, the advancement trajectory T is linear.

In accordance with one alternative embodiment (which is not illustrated), the advancement trajectory T is curvilinear.

In accordance with a further embodiment (which is not illustrated), the advancement trajectory T is a broken line consisting of different rectilinear lines and/or curvilinear portions. Conveying means 3 of the containers 100 are present in the tunnel 2 that enable the containers to advance along the advancement trajectory T.

For example, the conveying means 3 is of belt or chain type.

The drying module 1 comprises at least one first row of tubular elements 4 arranged inside the tunnel 2.

Each tubular element 4 of the first row extends along a corresponding prevalent direction A-A and has an opening 4a to dispense air onto the containers 100 in transit in the tunnel 2.

In particular, the prevalent direction A-A coincides with a longitudinal axis of the tubular element 4.

One of more of the tubular elements 4 of the first row is telescopic so as to have an adjustable length according to the corresponding prevalent direction A-A.

For example, FIG. 3 illustrates a tubular element 4 of the first row in a retracted position, whereas FIG. 4 illustrates this tubular element 4 in a position extending along the prevalent direction A-A.

In accordance with one preferred embodiment, all the tubular elements 4 of the first row are telescopic. This is illustrated, for example in FIG. 1, where it is seen that each tubular element 4 has a different length along the corresponding prevalent direction A-A.

Preferably, the tubular elements 4 of the first row are made of a stiff material, for example of metal. In accordance with one embodiment, the tubular elements 4 of the first row are made of steel, preferably made of stainless steel.

In accordance with one embodiment, it is possible to singly vary the inclination of the tubular elements 4 of the first row, i.e. it is possible to vary the angle formed by the prevalent direction A-A of each tubular element 4 with respect to the advancement trajectory T of the containers 100 in the tunnel 2. This possibility of adjusting the tilt will be explained better below.

In accordance with one embodiment, each tubular element 4 of the first row is rotatable around the corresponding prevalent direction A-A.

In accordance with the embodiment disclosed and illustrated here, the drying module 1 comprises also a second row of tubular elements 14 arranged inside the tunnel 2.

In particular, the first row and the second row extend from sides opposite the advancement trajectory T of the containers 100 inside the tunnel 2, as for example is visible in FIG. 2.

Preferably, the number of tubular elements 4 of the first row is the same as the number of tubular elements 14 of the second row. The choice of the number of tubular elements 4, 14 depends on the desired production rate. Thanks to the presence of two opposite rows of tubular elements 4, 14, dispensing of air onto the containers 100 in transit is uniform inside the tunnel 2.

Each tubular element 14 of the second row extends along a corresponding prevalent direction B-B and has an opening to dispense air onto the containers 100 in transit in the tunnel 2. The opening of the tubular element 14 is not illustrated, but is completely identical to the opening 4a.

In particular, the prevalent direction B-B coincides with a longitudinal axis of the tubular element 14.

One of more of the tubular elements 14 of the second row is telescopic so as to have an adjustable length according to the corresponding prevalent direction B-B.

For example, FIG. 3 illustrates a tubular element 14 of the second row in a retracted position, whilst FIG. 4 illustrates this tubular element 14 in a position extending along the prevalent direction B-B.

In accordance with one preferred embodiment, all the tubular elements 14 of the second row are telescopic.

The tubular elements 14 of the second row are preferably made of the same material used for the tubular elements 4 of the first row.

Preferably, the tubular elements 4, 14 of the first and of the second row are identical. In other words, they have the same shape, dimension and materials.

According to one embodiment, it is possible to singly vary the inclination of the tubular elements 14 of the second row, i.e. it is possible to vary the angle formed by the prevalent direction B-B of each tubular element 14 with respect to the advancement trajectory T of the containers 100 in the tunnel 2. This possibility of adjusting the inclination will be explained better below.

According to one embodiment, each tubular element 14 of the second row is rotatable around the corresponding prevalent direction B-B.

The drying module 1 comprises an air supply system 11 comprising at least one blower 5 configured to direct air to the tubular elements 4, 14.

In one variant embodiment (which is not illustrated), several blowers 5 are present for each drying module 1.

If only the first row of tubular elements 4 is present, the air supply system 11 also comprises a first conduit 6 from which the tubular elements 4 of the first row branch off. In particular, the tubular elements 4 of the first row are in fluid communication with the first conduit 6, which in turn receives air from the blower 5.

Each tubular element 4 of the first row branches off from the first conduit 6, the prevalent direction A-A thereof being arranged on a plane that is substantially orthogonal to the first conduit 6 and each tubular element 14 of the second row branches off from the second conduit 16, the prevalent direction B-B thereof being arranged on a plane substantially orthogonal to the second conduit 16.

In the embodiment disclosed and illustrated here, wherein two rows of tubular elements 4, 14 are present, the air supply system 11 also comprises a second conduit 16 from which the tubular elements 14 of the second row branch off. In particular, the tubular elements 14 of the second row are in fluid communication with the second conduit 16, which in turn receives air from the blower 5.

In accordance with one aspect of the invention, the first conduit 6 and the second conduit 16 are parallel to one another. Both conduits 6, 7 are in fluid communication with the blower 5.

In accordance with one aspect of the invention, the drying module 1 comprises a control system configured to vary the distance D between the first conduit 6 and the second conduit 16 and/or to adjust the height of these conduits 6, 16 with respect to the conveying means 3.

This control system is of automatic type and intervenes when conveying is stationary.

For example, FIG. 5 illustrates the first conduit 6 and the second conduit 16 in a first configuration that corresponds to a first distance D and at a first height compared with respect to the conveying means 3. FIG. 6 illustrates these conduits 6, 16 in a second configuration that corresponds to a second distance D (below the first) and to a second height (above the first).

It nevertheless has to be pointed out that the distance D and the height of the conduits 6, 16 can be varied independently, i.e. only the distance D can be varied (maintaining the height fixed), or only the height (maintaining the distance D fixed), or both can be varied.

In accordance with one aspect of the invention, the tubular elements 4, 14 are rotatably fitted to the corresponding conduits 6, 16 so that it is possible to vary the inclination for each tubular element 4, 14 independently of the others.

In particular, the tubular elements 4 of the first row are rotatably fitted to the first conduit 6 so as to rotate with respect to a first axis R1 that is orthogonal to the longitudinal extension of the first conduit 6. The tubular elements 14 of the second row are rotatably fitted to the second conduit 16 so as to rotate with respect to a second axis R2 that is orthogonal to the longitudinal extension of the second conduit 16.

Thanks to the installation of the tubular elements 4, 14 disclosed above, it is possible to vary singly the inclination of the tubular elements 4, 14 of the two rows, i.e. it is possible to vary the angle formed by the prevalent direction A-A, B-B of each tubular element 4, 14 with respect to the advancement trajectory T of the containers 100 in the tunnel 2.

For example, in FIG. 7, the tubular elements 4 of the first row all have the same inclination with respect to the advancement trajectory T.

In FIG. 8, on the other hand, each tubular element 4 of the first row is shown with a different inclination from the advancement trajectory T.

Further, as already said above, each tubular element 4, 14 is rotatable around the corresponding prevalent direction A-A, B-B.

Both the inclination and the rotation are adjusted manually with conveying stationary, in particular during test step.

In accordance with one variant embodiment which is not illustrated, a control system is provided for adjusting the inclination and rotation of the tubular elements 4, 14.

In accordance with one aspect of the invention, the opening 4a of each tubular element 4, 14 is made as a slit in a free end portion 7, 17 of the tubular element 4, 14.

In particular, the slit 4a has a longitudinal extension, which is preferably parallel to the corresponding prevalent direction A-A, B-B.

Preferably, the free end portion 7, 17 has an open end to which a closure 8, 18 is applied so as to convey the air to the slit 4a.

For example, in the embodiment disclosed and illustrated herein, the open end of each free end portion 7, 17 is cut at 45° with respect to the corresponding prevalent direction A-A, B-B. Preferably, each closure 8, 18 consists of a sheet plate welded to the body of the free end portion 7, 17 (which is visible for example in FIGS. 9-10).

As each tubular element 4, 14 is rotatable around the corresponding prevalent direction A-A, B-B, the position of the slit 4a is modified as a function of drying needs, as illustrated in FIGS. 9-10.

Preferably, each tubular element 4, 14 consists of a plurality of tubular portions that are slidable in relation to one another and are provided with rubber seals to reduce leaks.

A drying apparatus 10 can comprise just one drying module 1 like the one disclosed above or a plurality of drying modules 1 in a cascade, as a function of the desired production rate.

The conveying means 3 can be shared by the drying modules 1 alongside. For example, in FIG. 11 a drying apparatus 10 is illustrated comprising three drying modules 1, according to the present invention, which share the conveying means 3.

In other words, the conveying means 3 is made as a single device that traverses all the tunnels 2 of the drying modules 1.

From the description given, the features of a module and of an apparatus for sterilizing containers according to the present invention appear clear, as do the advantages thereof.

In particular, thanks to the telescopic structure of the tubular elements, it is easy and quick to vary the length of each of them so as to reach the desired drying zone precisely.

Further, as these tubular elements are also singly tiltable and rotatable around the axis thereof (which is the prevalent direction of extension), the position thereof can be easily and rapidly modified in space to adapt to different drying needs.

Further, in the event of a size change, the control system enables the distance between the first conduit and the second conduit to be varied rapidly and easily and/or the height of these conduits to be adjusted rapidly and easily. The great adjustment flexibility enables a wide range of products to be processed and several drying passes to be made on critical zones, for example where fluids collect.

The module and the drying apparatus proposed here thus have greater drying efficiency than known solutions. Further, having an air supply system based on stiff conduits and tubular elements, the head losses are reduced compared with the apparatus disclosed in European patent EP 2072405.

Lastly, it must be noted that the proposed module and apparatus are very compact.

1. A drying module for drying containers, comprising:
a tunnel inside which the containers move forwards along an advancement trajectory;
conveying means for conveying the containers inside the tunnel, wherein the drying module comprises at least one first row of tubular elements arranged inside the tunnel, each tubular element of the first row extending along a corresponding prevalent direction and having an opening to dispense air on the containers in transit in the tunnel, one or more of said tubular elements of the first row being telescopic so as to have an adjustable length according to the corresponding prevalent direction.

2. The drying module according to claim 1, further comprising a second row of tubular elements arranged inside the tunnel, each tubular element of the second row extending along a corresponding prevalent direction and having an opening to dispense air onto the containers in transit in the tunnel, one or more of said tubular elements of the second row being telescopic so as to have an adjustable length according to the corresponding prevalent direction, said first row and said second row being arranged on sides opposite the advancement trajectory of the containers inside the tunnel.

3. The drying module according to claim 2, further comprising an air supply system comprising:
at least one blower;
a first conduit from which the tubular elements of the first row branch off;
a second conduit from which the tubular elements of the second row branch off, said first conduit and said second conduit being parallel to one another and in fluid communication with the blower.

4. The drying module according to claim 3, wherein each tubular element of the first row branches off from the first conduit, the prevalent direction thereof being arranged on a plane substantially orthogonal to the first conduit and each tubular element of the second row branches off from the second conduit, the prevalent direction thereof being arranged on a plane substantially orthogonal to the second conduit.

5. The drying module according to claim 3, further comprising a control system configured to vary the distance between the first conduit and the second conduit and/or to adjust the height of said conduits with respect to the conveying means.

6. The drying module according to claim 3, wherein the tubular elements are rotatably fitted to the corresponding conduits so that it is possible to singly vary the inclination thereof.

7. The drying module according to claim 6, wherein each tubular element is rotatably fitted to the corresponding conduit so as to rotate around an axis that is orthogonal to the longitudinal extension of the conduit.

8. The drying module according to claim 3, wherein the tubular elements are rotatable around the corresponding prevalent direction.

9. The drying module according to claim 2, wherein the opening of each tubular element is made as a slit in a free end portion of the tubular element.

10. The drying module according to claim 9, wherein said free end portion has an open end to which a closure is applied so as to convey the air toward the corresponding opening.

11. The drying module according to claim 10, wherein said open end is cut at 45° with respect to the corresponding prevalent direction.

12. The drying module according to claim 2, wherein all the tubular elements are telescopic.

13. The drying module according to claim 2, wherein the tubular elements are made of a stiff material.

14. A drying apparatus comprising a plurality of drying modules according to claim 1, said drying modules being arranged in a cascade.

15. The drying apparatus according to claim 14, wherein the conveying means of the containers is made as a single device that traverses all tunnels of the drying modules.
